(19) United States
(12) Patent Application Publication
(10) Pub. No.: US 2010/0198444 A1
(43) Pub. Date: Aug. 5, 2010

(54) INTERMEDIATE PIVOT DEVICE FOR POSITIONING A PULLED IMPLEMENT

(75) Inventor: LAYTON W. JENSEN, Thurston, NE (US)

Correspondence Address: MERCHANT & GOULD PC, P.O. BOX 2903, MINNEAPOLIS, MN, 55402-0903, US

(73) Assignee: THURSTON MANUFACTURING COMPANY, Thurston, NE (US)

(21) Appl. No.: 12/364,553

(22) Filed: Feb. 3, 2009

(51) Int. Cl. G05D 1/00; A01B 63/14

(52) U.S. Cl. 701/26; 172/315; 701/50

(57) ABSTRACT

An intermediate pivot device is positioned between a towing vehicle and a pulled implement. The intermediate pivot device includes a positioning component that can be actuated in accordance with position implement control data to compensate for the drift of a pulled implement.

### BACKGROUND

In the agricultural industry, it is typical for a tractor to pull agricultural equipment to perform agricultural tasks in a field. Commonly, the tractor is set or driven to traverse a particular path within the field. During such a traversal of a particular path, the pulled agricultural equipment can “drift” from the path that the tractor is traversing. Such drift can occur from the weight of the pulled agricultural equipment as the tractor navigates steep topography. Drift may also occur when the pulled agricultural equipment is utilized to engage the soil of the field. Soil variances across the width of the soil engagement can cause the pulled agricultural equipment to drift or pull in a lateral direction and become out of alignment with the tractor. When such drift occurs, the pulled agricultural equipment may overlap a path that has already been traversed or may miss a portion of the path that was supposed to be traversed causing inaccurate equipment performance.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

Aspects of the disclosure pertain to an intermediate pivot device. The intermediate pivot device includes a positioning component that can be actuated in accordance with position implement control data to compensate for the drift of a pulled implement.

### BRIEF DESCRIPTION OF THE DRAWINGS

Non-limiting and non-exhaustive features are described with reference to the following figures, wherein like reference numerals refer to like parts throughout the various views unless otherwise specified.

FIG. 1 represents exemplary modular overview for aspects of utilizing an intermediate pivot device;

FIG. 2 represents an exemplary perspective view on an intermediate pivot device;

FIG. 3 represents an exemplary exploded perspective view of FIG. 2;

FIG. 4 represents an exemplary perspective view of an intermediate pivot device;

FIG. 5 represents an exemplary exploded perspective view of FIG. 4;

FIG. 6 represents an exemplary operational flow diagram for utilizing an intermediate pivot device;

FIG. 7 represents an exemplary block diagram of a computing device.

### DETAILED DESCRIPTION

Aspects of the disclosure are described more fully below with reference to the accompanying drawings, which form a part hereof. However, aspects of the disclosure can be implemented in many different forms and should not be construed as limited to the arrangements set forth herein; rather, these arrangements are provided so that this disclosure will be thorough and complete, and will convey the scope. Aspects of the disclosure can be practiced as methods, systems or devices. Accordingly, aspects can take the form of a structural implementation, a hardware implementation, a software implementation or an implementation combining aspects of structure, hardware or software. The following detailed description is, therefore, not to be taken in a limiting sense.

Regarding some features of the disclosure, aspects can be implemented (1) as a sequence of computer implemented steps running on a computing system, (2) as interconnected machine modules within the computing system, and/or (3) a combination of structural features with a sequence of instructions running on a computing system to cause an affect on the structural features. The implementation is a matter of choice dependent on the performance requirements of the computing system implementing the disclosure. Accordingly, the logical operations making up aspects described herein are referred to alternatively as operations, steps or modules.

“Drift” is a common problem in the agricultural industry. Drift occurs when pulled agricultural equipment shifts out-of-alignment with a path being traversed by a tractor or pulling vehicle. For example, a tractor may navigate steep terrain. The effect of the center of gravity of the agricultural equipment may change as the agricultural equipment navigates steep terrain. This change may cause the tractor to shift out-of-alignment with a navigation path being traversed by a tractor. As another example, agricultural equipment may engage the soil. In most situations, soil is not homogeneous throughout. For instance, soil may be comprised of sections or pockets of clay, sand, silt, rock, gravel, etc. When pulled agricultural equipment engages soil, the discrepancies in the soil may cause non-uniform forces to be exerted on the agricultural equipment across the width of the soil engaging portion of the agricultural equipment. The non-uniform forces cause the agricultural equipment to laterally pull or shift from the intended path of navigation. When such a lateral pull occurs, the agricultural equipment may drift out of alignment from the path of the tractor. Accordingly, the navigation path being traversed by the tractor does not necessarily equate to the navigation path of the pulled agricultural implement.

The disclosure herein pertains to an intermediate pivot device to economically and reliable remedy drift of the pulled implement. Installation of the intermediate pivot device, as set forth herein, does not require modification to a pulling vehicle and/or a drawbar of a pulling vehicle. As such, the intermediate pivot device is easily and economically installable. The intermediate pivot device, as set forth herein, does not require soil engagement to steer the pulled implement. As such, the intermediate pivot device, as set forth herein, is not susceptible to soil differential and bounce/shifting caused by objects under the soil. Also, the intermediate pivot device is accurate and reliable with a plurality of field conditions and equipment. The intermediate pivot device, as set forth herein, can include control modules for positioning automation. As such, drift can be remedied without undesirable user intervention, manual calculations, or operator judgment.

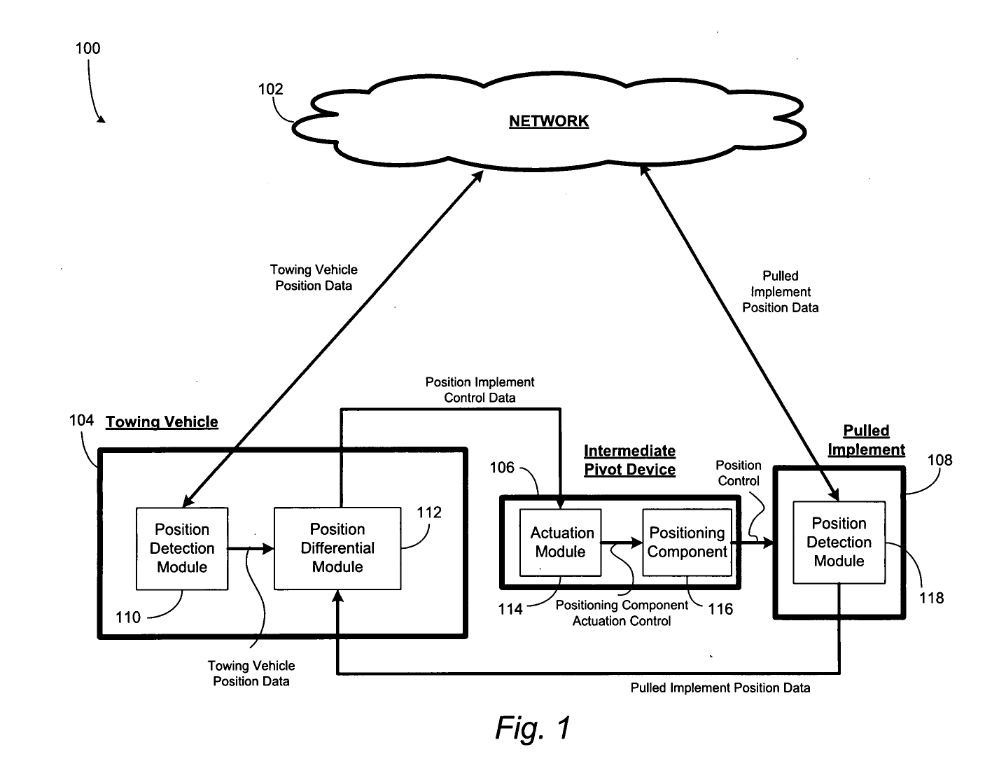

FIG. 1 represents exemplary modular overview of system 100 for aspects of utilizing an intermediate pivot device. The modular overview is but one example of many configurations of the control modules. The modular overview should not limit where the modules “reside” with respect to structural features associated with the disclosure. As more fully set forth herein, the modules can reside in a plurality of locations without departing from the functionality of the modules. Also, as more fully set forth below, the communication protocols of the modules of the modular overview 100 are not limited to any one communication protocol type. Depending on the configuration of system 100 various communication protocols can be utilized as more fully set forth below.

Modular overview 100 includes network 102, towing vehicle 104, intermediate pivot device 106, and pulled implement 108. Towing vehicle 104 can include position detection module 110 and position differential module 112. Intermediate pivot device 106 can include actuation module 114 and positioning component 116. Pulled implement 108 can include position detection module 118.

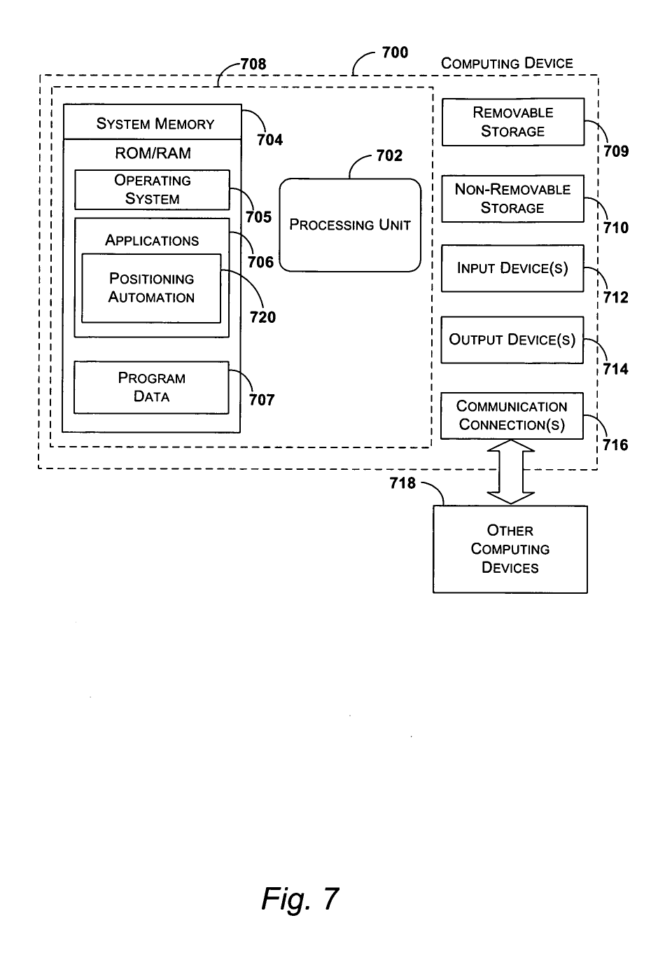

Position detection module 110 and position differential module 112 are depicted as residing with towing vehicle 104. However, modules 110 and 112 can reside in other locations. Moreover, modules 110 and 112 can include aspects of software, aspects of hardware, aspects of a structure, and/or any combination of software, hardware and structure capable of performing the functionality herein. Even though modules 110 and 112 are depicted as separate modules, modules 110 and 112 can be a single module performing the functionality of both module 110 and 112. Aspects of modules 110 and 112 can include some aspects of computing device 700 as described in FIG. 7.

Actuation module 114 and positioning component 116 are depicted as residing with intermediate pivot device 106. However, as more fully set forth below actuation module 114 and positioning component 116 can reside in other locations. Moreover, actuation module 114 and positioning component 116 can include aspects of software, hardware and structure capable of performing the functionality herein. Even though actuation module 114 and positioning component 116 are depicted separately, actuation module 114 and positioning component can be a single unit in that they can include related structure and functionality. Aspects of actuation module 114 and positioning component 116 can include some aspects of computing device 700 as described in FIG. 7.

Position detection module 118 is depicted as residing with pulled implement 108. However, as more fully set forth below module 118 can reside in other locations. Module 118 can include aspects of software, hardware and structure capable of performing the functionality herein. Aspects of module 118 can include some aspects of computing device 700 as described in FIG. 7

As stated, FIG. 1 includes towing vehicle 104. Towing vehicle 104 can include a vehicle such as a truck or car capable of towing pulled implement 108. In one aspect, towing vehicle 104 is an agricultural towing vehicle such as a tractor or the like.

Towing vehicle 104 includes position detection module 110. Position detection module 110 can be a module that is integrated into towing vehicle 104. Position detection module 110 can also take the form of a mobile device, a laptop computing device, a cellular device, a global positioning service (GPS) device, a personal digital assistant type device, and/or the like. In one aspect, position detection module 110 can be a global positioning service (GPS) module. Position detection module 110 can be configured to receive a signal from network 102 that includes current position data identifying a current position of towing vehicle 104. In one aspect, the current position data can be associated with a GPS identifier, a relative position identifier, and/or an identifier related to the triangulation of ground based towers or satellites. Position detection module 110 can be further configured to send position data to network 102 for data association, calculations, storage, further transmission and the like. In other aspects, position detection module 110 can be a relative position detection module. For example, position detection module 110 can receive position data associated with a position of towing vehicle 104 relative to one or more other objects. The other object can be a stationary object such as an antenna associated with a building or the like. In another aspect, the other object is pulled implement 108. Regardless of the physical location, communication protocol, or implementation of position detection module 110, position detection module 110 is configured to determine a position (geographically, relative or otherwise) of towing vehicle 104.

FIG. 1 indicates that position detection module 110 communicates with network 102 and position differential module 112. Such communication can be direct communication and/or indirect communication. For example, network 102 can be an open network, a closed network, a web-based network, a GPS network, a cellular network, a radio network and the like. As another example, the communication protocol can include a GPS protocol, a cellular protocol, a hard-wired protocol, a wireless protocol and/or an internet protocol. Moreover, communication association with position detection module 110 can include an intermediary computing device that first receives the communication prior to the communication reaching a destination.

Towing vehicle 104 can also include position differential module 112. Position differential module 112 can include a stand alone computer device. In other aspects, position differential module 112 can be a software module associated with position detection module 110. It is further contemplated that position differential module 112 can be a remote differential module residing on an external computing device or be associated with a web-based application. As indicated, position differential module 112 is configured to receive position data from position detection module 110, receive position data from position detection module 118, determine a position differential, and communicate position implement control data to actuation module 114. In another aspect, position implement control data may not be communicated to actuation module 114 if the position differential does not exceed a preset threshold. For example, a six inch drift of pulled implement 108 may not be a critical drift amount. However, a drift over twelve inches may be a critical drift amount. The communication protocol can include a GPS protocol, a cellular protocol, a hard-wired protocol, a wireless protocol, an internet protocol and/or the like. Moreover, communication associated with position differential module 112 can include an intermediary computing device that first receives the communication prior to the communication reaching a destination. Regardless of the physical location, protocol, or implementation of position differential module 112, position differential module 112 is configured to communicate with actuation module 114 based on a position differential between towing vehicle 104 and pulled implement 108.

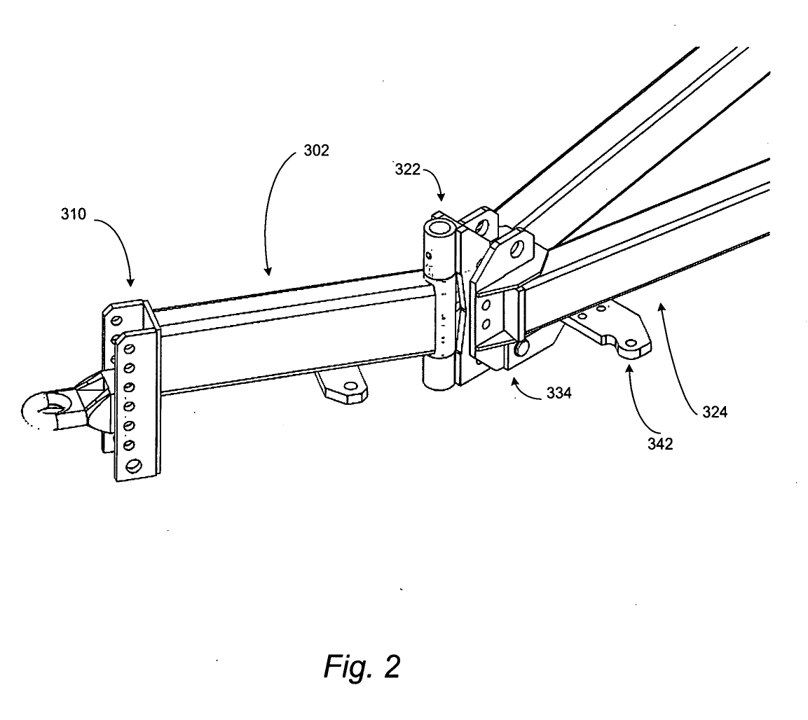

FIG. 1 includes intermediate pivot device 106. A first end of intermediate pivot device 106 is configured to connect to towing vehicle 104 and a second end portion of pivot device is configured to connect to pulled implement 108 via a pivot and positioning component 116. The structural features of intermediate pivot device are more fully discussed below in association with FIGS. 2-5.

Intermediate pivot device 106 can include actuation module 114. In one aspect, actuation module 114 can include a control box with one or more hydraulic valves for causing the actuation of positioning component 116 via a hydraulic connection to positioning component 116. Even though hydraulics are discussed herein, the specification is not limited to hydraulics, hydraulic valves and/or hydraulic connections associated with the actuation module. The actuation module may include any device to cause the movement as more fully set forth herein. For example, the actuation module may cause actuation through electronics, pneumatics and the like. Actuation module 114 can be configured to receive position implement control data from position differential module 112 and open/close hydraulic valves according to the position implement control data to move the positioning component 116 and cause a lateral shift of pulled implement 108. For example, position differential module 112 can send an electronic signal to actuation module 114 to control hydraulic valves associated with actuation module 114. The opening of hydraulic valves causes hydraulic fluid to cause the actuation of positioning component 116. As other examples, the communication protocol between position differential module 112 and actuation module 114 can include a GPS protocol, a cellular protocol, a hard-wired protocol, a wireless protocol, an internet protocol and/or the like. Moreover, communication to actuation module 114 can include an intermediary computing device that first receives the communication prior to the communication reaching actuation module 114. Even though actuation module 114 is depicted in FIG. 1 as being associated with intermediate pivot device 106, actuation module 114 may be located on towing vehicle 104 or pulled implement 108 and connected to positioning component 116 via hydraulic connections. Regardless of the physical location, communication protocol, or implementation of actuation module 114, actuation module 114 is configured to receive a signal and control actuation in association with the received signal.

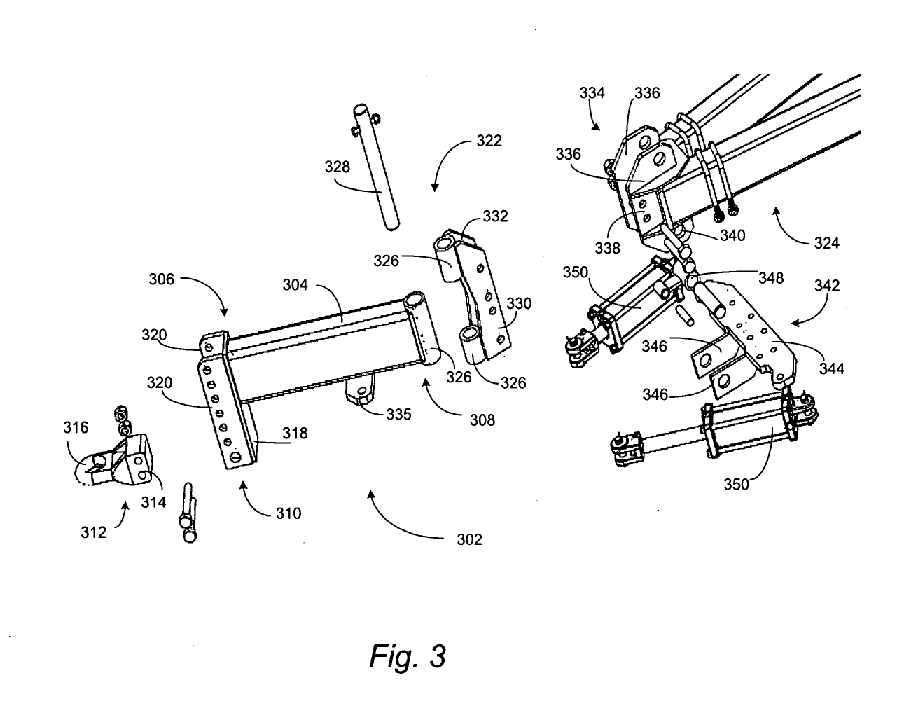

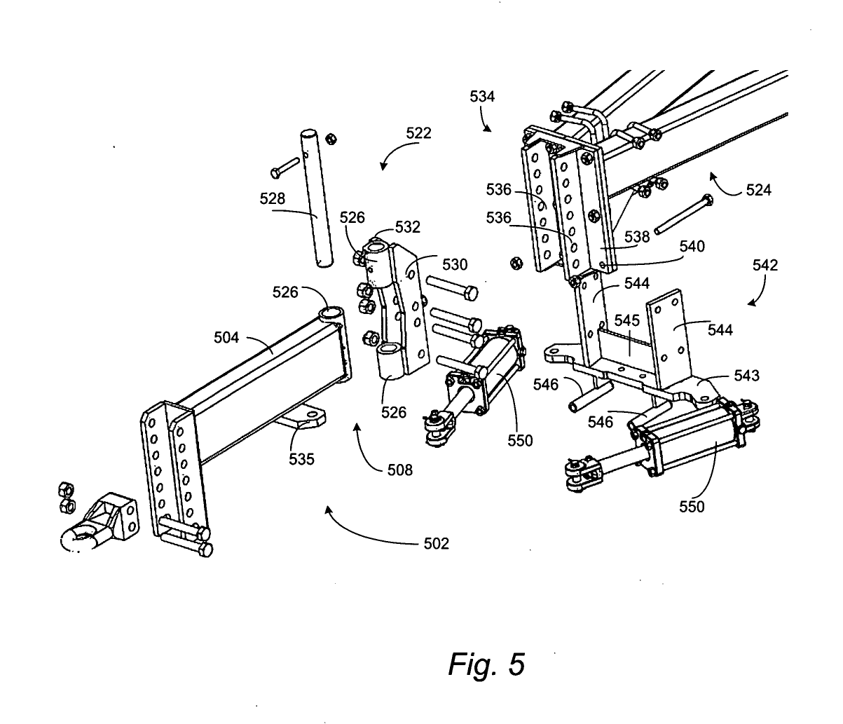

Intermediate pivot device 106 further includes positioning component 116. In one aspect, positioning component 116 is a hydraulic actuator such as the hydraulic actuators depicted in FIGS. 3 and 5. The positioning component 116 can be in fluid communication with actuation module 114. The positioning component 116 is also coupled to intermediate pivot device 106 and pulled implement 108 as indicated in FIGS. 2-5. In response to the fluid communication, positioning component 116 can be moved to cause lateral positioning or lateral maintenance of a position of pulled implement 108 with respect to towing vehicle 104 and/or with respect to another predetermined path. Regardless of the implementation of positioning component 116, positioning component 116 is configured to hydraulically communicate with actuation module 114 to actuate a movement of the positioning component 116.

Pulled implement 108 can include position detection module 118. Position detection module 118 can be a module that is integrated into pulled implement 108. Position detection module 118 can also take the form of a mobile device, a laptop computing device, a cellular device, a global positioning service (GPS) device, a personal digital assistant type device, and/or the like. In one aspect, position detection module 118 can be a global positioning service (GPS) module. Position detection module 118 can be configured to receive a signal from network 102 that includes current position data identifying a current position of pulled implement 108. In one aspect, the current position data can be associated with a GPS identifier, a relative position identifier, and/or an identifier related to the triangulation of cellular towers. Position detection module 118 can be further configured to send position data to network 102 for data association, calculations, storage, further transmission and the like. In other aspects, position detection module 118 can be a relative position detection module. For example, position detection module can receive position data associated with a position of pulled implement 108 relative to one or more other objects. The object can be a stationary object such as an antenna associated with a building or the like. In another aspect, the object is towing vehicle 104. Regardless of the physical location, protocol, or implementation of position detection module 118, position detection module 118 is configured to determine a position of pulled implement 108.

FIG. 1 indicates that position detection module 118 communicates with network 102 and position differential module 112. Such communication can be direct communication and/or indirect communication. For example, network 102 can be an open network, a closed network, a web-based network, a GPS network, a cellular network, a radio network and/or the like. As another example, the communication protocol can include a GPS protocol, a cellular protocol, a hard-wired protocol, a wireless protocol, an internet protocol and/or the like. Moreover, communication association with position detection module 118 can include an intermediary computing device that first receives the communication prior to the communication reaching a destination.

With regard to the system of FIG. 1, the system can be a continuous system for continuously determining position implement control data. The system can be a periodic system for periodically determining position implement control data. The system can also be a manually activated system for determining position implement control data upon a user input.

As one example of system 100 in association with a farming application, towing vehicle 104 may include a tractor, intermediate pivot device may include an implement as depicted in FIGS. 2-5 and pulled implement 108 may include farm equipment. Further to this example, position detection modules 110 and 118 may include GPS receivers and positioning component 116 may include a hydraulic actuator. In this example, a course for the tractor to traverse may be associated with a computing device in communication with the tractor. As the tractor traverses the course, the pulled farm equipment may drift laterally from the course for the reasons indicated above. The position differential module receives position data of the tractor and position data from the farm equipment. A positional difference is calculated by the position differential module. For example, the position difference may include a distance of lateral drift of the farming equipment with respect to the tractor. From the position difference, the position differential module calculates an amount of actuation required to counter the lateral drift. The position differential module sends a signal to the actuation module to cause a hydraulic valve to open and move the hydraulic actuators an appropriate amount to laterally move the farm equipment to counter the lateral drift. In this manner, the position of the farm equipment is substantially maintained in alignment with the tractor.

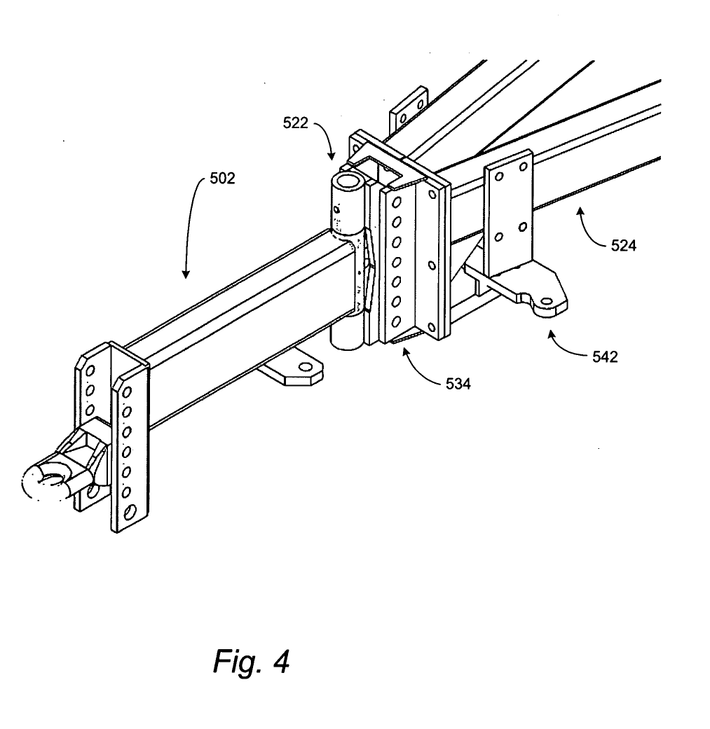

FIG. 2 represents an exemplary perspective view of aspects of an intermediate pivot device coupled to a pulled implement. FIG. 3 represents an exemplary exploded perspective view of aspects of the intermediate pivot device of FIG. 2. FIG. 4 represents an exemplary perspective view of aspects of an intermediate pivot device coupled to the pulled implement. FIG. 5 represents an exemplary exploded perspective view of aspects of the intermediate pivot device of FIG. 4. FIGS. 2 and 3 represent an intermediate pivot device for a first type of pulled implement tongue and FIGS. 4 and 5 represent an intermediate pivot device for a second type of pulled implement tongue. These examples are not meant to limit the scope to any particular combination of features. Based on the disclosure herein, a person of skill in the art will understand that the features may be arranged in other combinations depending on the type of pulled implement tongue.

Intermediate pivot device 302 includes elongated support 304 having first end portion 306 and second end portion 308. In one aspect, elongated support 304 is tubing. Elongated support 304 can include any type of cross section such as a rectangular cross section, circular cross section, triangular cross section, and the like. Elongated support 304 can also be comprised of a hollow tubing or include solid fabrication.

First end portion 306 includes receiving bracket 310. In some aspects, receiving bracket 310 can be structured to couple with connector 312. Connector 312 can include first end portion 314 for coupling to receiving bracket 310 and second end portion 316 for coupling to a drawbar of a pulling vehicle (not shown). In one example, receiving bracket 310 can be described as a “bird cage” type bracket however other types of receiving brackets may be utilized including any type of hitch bracket or the like. Receiving bracket 310 can include base plate 318 coupled to first end portion 306 and two side plates 320 coupled to base plate 318. Side plates 320 can define a channel. Side plates 320 can include a plurality of holes which allow first end portion 314 of connector 312 to be removably received by the channel and removable secured to side plates 320. In one aspect, first end portion 314 of connector 312 is selectively vertically positionable depending on which of the plurality of holes are utilized to engage first end portion 314 of connector 312. In another aspect, receiving bracket 310 can be coupled directly to the pulling vehicle drawbar without connector 312. In one aspect, intermediate pivot device 302 can be coupled to a drawbar of a pulling vehicle without modification to the drawbar of the pulling vehicle. Also, in one aspect, intermediate pivot device 302 can be coupled to a drawbar of a pulling vehicle to provide a passive coupling to the pulling vehicle. For example, the coupling may allow lateral movement when the pulling vehicle makes a turn within a filed. The movement of the passive coupling may be compensated for or “overridden” by the hinge 322 as more fully set forth below when the pulling vehicle is traversing a path in a field (to compensate for drift). In one non-limiting example, actuators 350 may not be coupled to the tractor. In another non-limiting example, connector 312 may be the only mechanical coupling between the pulling vehicle and intermediate pivot device 302.

Second end portion 308 of intermediate pivot device 302 includes hinge 322. Hinge 322 can include a pivot, hinge, piano-type hinge and/or any other structure that allows rotation. Hinge 322 is configured to couple to implement tongue 324 and to provide rotation to facilitate an axis of rotation for implement tongue 324 with respect to elongated support 304 of intermediate pivot device 302. Hinge 322 can include pin receiving portions 326 for receiving pin 328, first pivot plate 330 and second pivot plate 332. First hinge plate 330 and second hinge plate 332 may include a plurality of holes for selective coupling to pulled implement tongue receiving bracket 334.

Intermediate pivot device 302 can include actuator support 335. In one aspect actuator support plate 335 is coupled to a bottom portion of elongated support 304. Such coupling may include epoxy, fasteners, welding, and/or any other types of coupling for securing or removably securing actuator support plate 335 to intermediate pivot device 302. As will be further described herein, actuator support 335 may also be connected to a top portion of elongated support 304. In one aspect, actuator support 335 may include at least one hole at an end portion of actuator support 335 to allow coupling of actuator 350. In one aspect, actuator support 335 is coupled to elongated support 304 between first end portion 306 and second end portion 308. In other aspects, it is contemplated that actuator support 335 can be coupled to receiving bracket 310.

Implement tongue 324 includes pulled implement tongue receiving bracket 334. Pulled implement tongue receiving bracket 334 can include receiving plates 336. Receiving plates 336 can include a channel for operatively receiving and coupling to first hinge plate 330 and second hinge plate 332. Receiving plates 336 can include forward holes 338 for selectively coupling first hinge plate 330 and second hinge plate 332 to the receiving plates 336. Receiving plates 336 also include rearward holes 340 for coupling actuator bracket 342 to receiving plates 336.

Actuator bracket 342 can includes mounting plate 344 and support arms 346. In one aspect mounting plate 344 is substantially flat and support arms 346 are coupled to the underside of mounting plate 344 and extend forwardly from the mounting plate 344. Mounting plate 344 can include a plurality of holes for receiving a bolt or U-bolt to secure actuator bracket 342 to implement tongue 324. However, actuator bracket 342 may be coupled to implement tongue 324 in a variety of fashions including epoxy, welding, fasteners and the like. Support arms 346 can include holes for aligning with rearward holes 340 to provide additional support for actuator bracket 342. In another aspect, auxiliary connector 348 may be used for addition support for actuator bracket 342. Auxiliary connector 342 can be coupled to support arms 346, receiving plates 336, first hinge plate 330 and second hinge plate 332. Auxiliary connector 348 can be received by the channel formed by pulled implement tongue receiving bracket 334. Auxiliary connector 346 includes first and second end portions. A first end portion can align with rearward holes 340 and the holes of support arms 346 to receive a fastener therethrough. The second end portion of auxiliary connector 348 can be received by a channel formed by first hinge plate 330 and second hinge plate 332. The second end portion can align with one or more of the holes of the first hinge plate 330 and second hinge plate 332 to receive a fastener therethrough. This type of coupling is but one example. Auxiliary connector 348 may be coupled via fasteners, epoxy, welding and the like.

Actuators 350 include first and second ends. First ends of the actuators are rotatably coupled to actuator bracket 342. The second ends of the actuators are rotatably coupled to actuator support 335. Accordingly, lateral position of pulled implement tongue 324 can be operatively controlled via hinge 322 and actuators 350. Also, even though multiple actuators are depicted in FIG. 3, one actuator can be utilized.

Even though FIG. 3 depicts actuator bracket 342 and actuator support 335 as being coupled to the bottom side of the pulled implement tongue 324 and the elongated support 304, respectively, the actuator bracket 342 and actuator support 335 may also be coupled to the top side of pulled implement tongue 324 and elongated support 304, respectively. The topside coupling would not affect the functionality or utilization of intermediate pivot device 302. Furthermore, even actuator support 335 is depicted as being coupled to the bottom side of the elongated support 304, actuator support 335 may also be coupled to elongated support 304 by fabricating actuator support 335 to the sides of the elongated support 304 or positioning actuator support through the elongated support 304. As should be evident through the disclosure herein, elements of FIG. 3 may be packaged and sold as a kit. In one aspect, the kit may include at least intermediate pivot device 302. In another aspect, the kit may include at least intermediate pivot device 302 and actuator bracket 342. In other aspects, the kit may include at least intermediate pivot device 302, actuator bracket 342 and actuator 350. In still other aspects, the kit may include at least intermediate pivot device 302, actuator bracket 342, actuator 350, and a computer readable storage medium for performing one or more of the functions indicated in FIG. 1. In yet another aspect, the kit may include at least intermediate pivot device 302, actuator bracket 342, actuator 350, a computer, and a computer readable storage medium for performing one or more of the functions indicated in FIG. 1.

As stated, FIG. 4 represents an intermediate pivot device attached to a pulled implement tongue. FIG. 5 is referenced herein to set forth some features of the intermediate pivot device that are different from FIG. 3.

Second end portion 508 of intermediate pivot device 502 includes a hinge 522. Hinge 522 can include a pivot, hinge, piano-type hinge and/or any other structure that allows rotation. Hinge 522 is configured to couple to implement tongue 524 and to provide rotation to facilitate an axis of rotation for implement tongue 524 with respect to elongated support 504 of intermediate pivot device 502. Hinge 522 can include pin receiving portions 526 for receiving pin 528, first hinge plate 530 and second hinge plate 532. First hinge plate 530 and second hinge plate 532 may include a plurality of holes for selective coupling to pulled implement tongue receiving bracket 534.

Intermediate pivot device 502 can include actuator support 535. In one aspect actuator support plate 535 is coupled to a bottom portion of elongated support 504. Such coupling may include epoxy, fasteners, welding, and/or any other types of coupling for securing or removably securing actuator support plate 535 to intermediate pivot device 502. As will be further described herein, actuator support 535 may also be connected to a top portion of elongated support 504. In one aspect, actuator support 535 may include at least one hole at an end portion of actuator support 535 for coupling to actuator 550. In one aspect, actuator support 535 is coupled to elongated support 504 between first and second end portions of elongated support 504. In other aspects, it is contemplated that actuator support 535 can be coupled to receiving bracket 310.

Implement tongue 524 includes pulled implement tongue receiving bracket 534. In one aspect, pulled implement tongue receiving bracket 534 is a “bird cage” style receiving bracket. Pulled implement tongue receiving bracket 534 can include receiving plates 536. Receiving plates 536 can include a channel for operatively receiving first hinge plate 530 and second hinge plate 532. Receiving plates 536 can include a plurality of holes for selectively coupling first hinge plate 530 and second hinge plate 532 to the receiving plates 536. Pulled implement tongue receiving bracket 534 can also include base plate 538. Base plate 538 can be coupled to pulled implement tongue 524 and receiving bracket 534. Base plate 538 may include a plurality of holes 540 or openings for receiving a fastener therethrough. Base plate 538 may be further coupled to actuator bracket 542 as indicated below.

Actuator bracket 542 can include mounting plate 543, first and second side support plates 544, intermediate support 545, and first and second lower supports 546. In one aspect mounting plate 543 is substantially flat. First and second side support plates 544 are spaced apart and extend upwardly from mounting plate 543. Intermediate support 545 is coupled to first and second side supports 544 and extends therebetween. First and second lower supports 546 are coupled to the bottom of mounting plate 543 and are configured to couple to base plate 543 via a fastener, welding, epoxy or the like. First and second side supports 544 can include a plurality of holes for receiving a bolt or U-bolt to secure actuator bracket 542 to implement tongue 524. However, actuator bracket 342 may be coupled to implement tongue 524 in a variety of fashions including epoxy, welding, fasteners and the like. Lower supports 546 can include holes or channels for aligning with rearward holes 540 to provide additional support for actuator bracket 542.

Actuators 550 include first and second ends. First ends of the actuators are coupled to actuator bracket 542. The second ends of the actuators are coupled to actuator support 535. Accordingly, lateral position of pulled implement tongue 524 can be operatively controlled via hinge 522 and actuators 550. Also, even though multiple actuators are depicted in FIG. 5, one actuator can be utilized.

Even though FIG. 5 depicts actuator bracket 542 and actuator support 535 as being coupled to the bottom side of the pulled implement tongue 524 and the elongated support 504, respectively, the actuator bracket 542 and actuator support 535 may also be coupled to the top side of pulled implement tongue 524 and elongated support 504, respectively. Such a coupling would not affect the functionality or utilization of intermediate pivot device 502. Furthermore, even actuator support 535 is depicted as being coupled to the bottom side of the elongated support 504, actuator support 535 may also be coupled to elongated support 504 by fabricating actuator support 535 to the sides of the elongated support 504 or positioning actuator support through the elongated support 504. As should be evident through the disclosure herein, elements of FIG. 5 may be packaged and sold as a kit. In one aspect, the kit may include at least intermediate pivot device 502. In another aspect, the kit may include at least intermediate pivot device 502 and actuator bracket 542. In other aspects, the kit may include at least intermediate pivot device 502, actuator bracket 542 and actuator 550. In still other aspects, the kit may include at least intermediate pivot device 502, actuator bracket 542, actuator 550, and a computer readable storage medium for performing one or more of the functions indicated in FIG. 1. In yet another aspect, the kit may include at least intermediate pivot device 502, actuator bracket 542, actuator 550, a computer, and a computer readable storage medium for performing one or more of the functions indicated in FIG. 1.

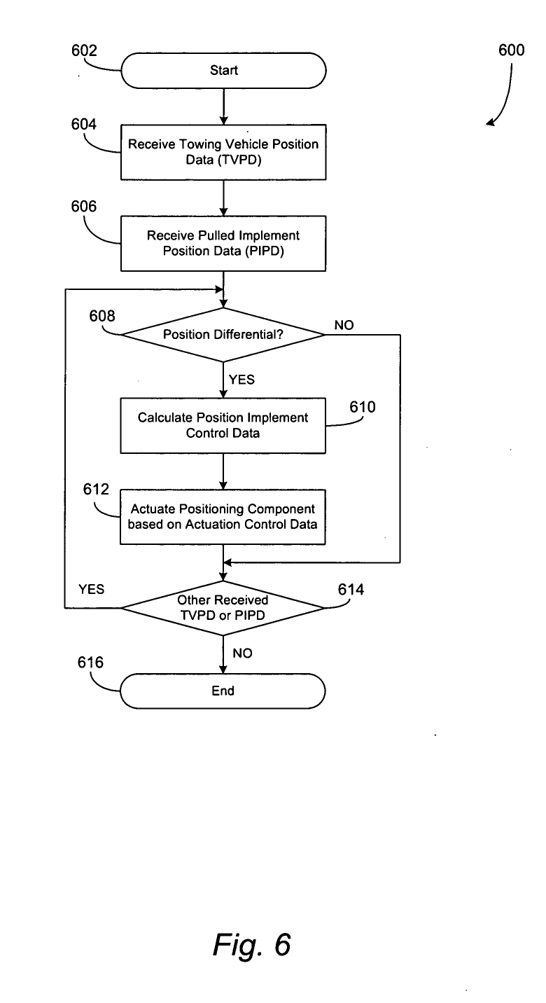

FIG. 6 represents an exemplary operational flow diagram for utilizing an intermediate pivot device. Operational flow 600 begins at start operation 602 and continues to operation 604. At operation 604, towing vehicle position data is received. As described above in association with FIG. 1, the towing vehicle position data may indicate a current position of the towing vehicle. The towing vehicle position data can be received by positioning module 110. The current position may be indicated by a GPS identifier, a relative position identifier, an identifier related to the triangulation of cellular towers and the like.

Operational flow 600 continues to operation 606. At operation 606, pulled implement position data is received. As described above in association with FIG. 1, the pulled implement position data may indicate a current position of the pulled implement. The pulled implement position data can be received by positioning module 118. The current position may be indicated by a GPS identifier, a relative position identifier, an identifier related to the triangulation of cellular towers and the like. Even though operational flow 600 indicates operation 604 before operation 606, the two operations may also be switched. For example, the pulled implement position data may be received before towing vehicle position data. Also, the towing vehicle position data may be received at the same time as the pulled implement position data.

Operational flow 600 continues to decision operation 608. At decision operation 608, a determination is made as to whether a position differential exists between the towing vehicle position data and the pulled implement position data. The determination of a position differential may be associated with a lateral position differential related to a traversal path of the towing vehicle with respect to a path of a pulled implement. The positional differential may be determined at position differential module 112 depicted in FIG. 1. In one aspect the determination of whether a position differential exists is based on a lateral threshold. As a non-limiting example, an operator may set a lateral threshold at one foot. As such, the lateral threshold allows one foot lateral movement of the pulled implement without causing a position adjustment of the pulled implement. If the pulled implement drifts beyond the one foot lateral threshold, operational flow 600 continues as indicated below. It is contemplated, however, that decision operation 608 does not include a threshold.

If a lateral position differential does not exist (either based on a threshold or not based on a threshold), operational flow 608 continues to operation 614 as discussed below. If a lateral position differential does exist (either based on the threshold or not based on a threshold), operational flow 600 continues to operation 610.

At operation 610 position implement control data is calculated. As an example, the position implement control data may include an actuation amount of an actuator associated with the intermediate pivot device to compensate for the position differential. For example, a one foot drift of the pulled implement can equate to a one inch movement of an actuator to put the pulled implement back in alignment with the position of the towing vehicle. As another example when the system is continuous, the position implement control data may move the actuator until the position differential module determines that the pulled implement is within a lateral threshold. In such a situation the position implement control data acts as an actuator on/off switch.

Operational flow 600 continues to operation 612. At operation 612, the actuators are actuated based on the actuation control data to offset a lateral differential. In one aspect, the position implement control data is received by a control of an actuator. Hydraulic fluid is then communicated to the actuator to cause the actuator to extend or retract based on the actuation control data. As an example associated with FIG. 3, intermediate pivot device 302 may be coupled to a towing vehicle at first end portion 306 to restrain pivotal of first end portion 306 with respect to the towing vehicle. Actuator 350 receives hydraulic fluid based on the position implement control data to cause actuator 350 to actuate between actuator support plate 335 and actuator bracket 342. Such actuation causes implement tongue 324 to rotate about an axis formed by hinge 322 that is coupled to second end portion 308 of intermediate pivot device 302. As an example associated with FIG. 5, intermediate pivot device 502 may be coupled to a towing vehicle at a first end portion to restrain pivotal movement of the first end portion with respect to the towing vehicle. Actuator 550 receives hydraulic fluid based on the position implement control data to cause actuator 550 to actuate between actuator support plate 535 and actuator bracket 542. Such actuation causes implement tongue 524 to rotate about an axis formed by hinge 522 coupled to second end portion 508 of intermediate pivot device 502.

From operation 612, operational flow 600 continues to decision operation 614. At decision operation 614, it is decided whether other towing vehicle position data or other pulled implement position data is received. If so, operational flow 600 loops back to decision operation 608. If not, operational flow continues to end operation 616.

Operational flow 600 can be a continuous operation. For example, position differential module 112 can continuously receive position data. Operational flow 600 can be a periodic operation. For example, position differential module 112 can periodically receive position data. In other aspects, operational flow 600 can be activated based on a user input. For example, position differential module 112 can receive position data in response to an operator selection or input.

FIG. 7 represents an exemplary system computing device, such as computing device 700. In a basic configuration, computing device 700 can include any type of stationary computing device or a mobile computing device. For example, a stationary device can include a desktop computing device, a computing device stationary with respect to a vehicle, etc. As another example, a mobile computing device can include a laptop, a cellular telephone, a personal digital assistant type device, a positioning device, a global positioning service type device, etc. Computing device 700 typically includes at least one processing unit 702 and system memory 704. Depending on the exact configuration and type of computing device, system memory 704 can be volatile (such as RAM), non-volatile (such as ROM, flash memory, and the like) or some combination of the two. System memory 704 typically includes operating system 705, one or more applications 706, and can include program data 707. In one embodiment, applications 706 further include application 720 for positioning automation. Application 720 can include software configured to perform the functionality set forth above. This basic configuration of computing device 700 is illustrated in FIG. 7 by those components within dashed line 708.

Computing device 700 can also have additional features or functionality. For example, computing device 700 can also include additional data storage devices (removable and/or non-removable) such as, for example, magnetic disks, optical disks, or tape. Such additional storage is illustrated in FIG. 7 by removable storage 709 and non-removable storage 710. As described herein, computer-readable storage mediums can be volatile and non-volatile, removable and non-removable media implemented in any method or technology for storage of information, such as computer-readable instructions, data structures, program modules or other data. System memory 704, removable storage 709 and non-removable storage 710 are all examples of computer-readable storage mediums. Computer-readable storage mediums includes but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information and which can be accessed by computing device 700. Any such computer-readable storage mediums can or can not be part of device 700. Computing device 700 can also have input device(s) 712 such as a keyboard, mouse, pen, voice input device, touch input device, etc. Output device(s) 714 such as a display, speakers, printer, etc., can also be included.

Computing device 700 also contains communication connection(s) 716 that allow the device to communicate with other devices or other computing devices 718, such as over a network, a wireless network, a cellular network, a global positioning network, a hardwired network, and electrical network, a switch network, etc. Communication connection(s) 716 is an example of communication media. Communication media typically embodies computer-readable instructions, data structures, program modules, electrical signal instructions, or other data in a modulated data signal such as a carrier wave or other transport mechanism and includes any information delivery media. The term “modulated data signal” can include a signal that has one or more of its characteristics set or changed in such a manner as to encode information in the signal. By way of example, and not limitation, communication media can include wired media such as a wired network or direct-wired connection, and wireless media such as acoustic, RF, infrared and other wireless media.

Although the disclosure has been described in language that is specific to structural features and/or methodological steps, it is to be understood that the features defined in the appended claims are not necessarily limited to the specific features or steps described. Rather, the specific features and steps are disclosed as forms of implementing the claimed features. Since many aspects of the disclosure can be made without departing from the spirit and scope of the disclosure, the invention resides in the claims hereinafter appended.

What is claimed is:

1. An intermediate pivot device for positioning a pulled implement with respect to a towing vehicle, comprising:
an intermediate pivot structure including a first end portion configured for connection to the towing vehicle and a second end portion configured for connection to the pulled implement, the intermediate pivot structure further including a pivot location between the first end portion and the second end portion for providing lateral pivotal movement between the first end portion and the second end portion; and
an actuator for generating relative lateral pivotal movement between the first end portion and the second end portion at the pivot location.

2. The intermediate pivot device of claim 1, further comprising a first bracket for connecting the actuator to the intermediate pivot structure and a second bracket for connecting the actuator to the pulled implement.

3. The intermediate pivot device of claim 1, wherein the second bracket includes a mounting plate and a support arm, the support arm being coupled to a pulled implement tongue receiving bracket.

4. The intermediate pivot device of claim 3, further comprising an auxiliary connector having a first auxiliary end portion and a second auxiliary end portion, the first auxiliary end portion being coupled to the support arm and the pulled implement tongue receiving bracket, the second auxiliary end portion being coupled to the second end portion of the intermediate pivot device.

5. The intermediate pivot device of claim 2, wherein the second bracket includes a mounting plate having a top side and a bottom side, the top side of the mounting plate having first and second side support plates, the bottom side of the mounting plate having a lower support being coupled to a pulled implement tongue receiving bracket.

6. The intermediate pivot device of claim 5, wherein the second bracket includes an intermediate support coupled to the mounting plate.

7. The intermediate pivot device of claim 2, wherein actuation of the actuator support between the first bracket and the second bracket is based on control data calculated by a position differential module

8. The intermediate pivot device of claim 7, wherein the control data is based on a differential between towing vehicle position data and pulled implement position data.

9. The intermediate pivot device of claim 8, wherein the differential between towing vehicle position data and pulled implement position data is based on a predetermined differential threshold.

10. An intermediate pivot device for positioning agricultural equipment with respect to a tractor, comprising:
an elongated support having a first end portion and a second end portion, the first end portion configured for coupling to the tractor, the second end portion having a hinge configured for pivotal coupling to a pulled implement tongue receiving bracket;
an actuator support coupled to the intermediate pivot device;
an actuator bracket coupled to the agricultural equipment.
an actuator having an actuator first end portion and an actuator second end portion, the actuator first end portion being coupled to the actuator support, the actuator second end portion being coupled to the actuator bracket; and
a controller in communication with the actuator, wherein the controller receives control data from a position differential module and hydraulically communicates with the actuator based on a position differential calculated by the position differential module in order to actuate the actuator and cause movement of the agricultural equipment about an axis formed by the hinge.

11. The intermediate pivot device of claim 10, wherein the actuator bracket includes a mounting plate and a support arm, the support arm being coupled to the pulled implement tongue receiving bracket.

12. The intermediate pivot device of claim 11, further comprising an auxiliary connector having a first auxiliary end portion and a second auxiliary end portion, the first auxiliary end portion being coupled to the support arm and the pulled implement tongue receiving bracket, the second auxiliary end portion being coupled to the hinge.

13. The intermediate pivot device of claim 10, wherein the actuator bracket includes a mounting plate having a top side and a bottom side, the top side of the mounting plate having first and second side support plates, the bottom side of the mounting plate having a lower support being coupled to the pulled implement tongue receiving bracket.

14. The intermediate pivot device of claim 13, wherein the actuator bracket includes an intermediate support coupled to the mounting plate.

15. The intermediate pivot device of claim 10, wherein the position differential is based on a differential between towing vehicle position data and pulled implement position data.

16. The intermediate pivot device of claim 15, wherein the differential between towing vehicle position data and pulled implement position data is based on a predetermined differential threshold.

17. A method for positioning a pulled implement with respect to a towing vehicle, the method comprising:
providing an intermediate pivot device, wherein the intermediate pivot device includes a hinge end, an actuator bracket, and an actuator that operatively couples the intermediate pivot device to the actuator bracket;
obtaining a position identifier related to a towing vehicle and a position identifier related to a pulled implement;
calculating a position differential based on the position identifier related to the towing vehicle and the position identifier related to the pulled implement;
based on the position differential, causing the actuator to actuate in order to laterally move the actuator bracket, about an axis formed by the hinge end, to reduce the position differential.

18. The method of claim 17, wherein the position differential is based on a predetermined lateral threshold.

19. The method of claim 17, wherein the intermediate pivot device includes a passive lateral movement connector at an opposite end as the hinge end.

20. The method of claim 17, wherein obtaining a position identifier of the towing vehicle and the position identifier of the pulled implement includes a position detection module that obtains at least one member of a group comprising: a GPS identifier, a relative positioning identifier, and a cellular triangulation identifier.
